(19) United States
(12) Patent Application Publication
(10) Pub. No.: US 2013/0185710 A1
(43) Pub. Date: Jul. 18, 2013

(54) DATA COLLECTION AND ANALYSIS DEVICE AND OPERATING METHOD OF THE SAME

(71) Applicant: CHING-PIN CHEN, TAIPEI CITY (TW)

(72) Inventor: CHING-PIN CHEN, TAIPEI CITY (TW)

(73) Assignee: CHY FIREMATE CO., LTD., TAINAN CITY (TW)

(21) Appl. No.: 13/348,729

(22) Filed: Jan. 12, 2012

(51) Int. Cl. G06F 9/44

(52) U.S. Cl. 717/173

(57) ABSTRACT

A data collection and analysis device that downloads and updates firmware from operation platforms and an operating method of the same are revealed. The device includes a core unit, a program conducting and loading unit connected to the core unit, a translation unit connected to the core unit and the program conducting and loading unit, and a communication interface connected to the program conducting and loading unit, and the translation unit. The core unit is connected to a transmission unit, a memory unit, an indicator light unit, and an input unit. Thus users don't need to buy different data collection and analysis devices and the equipment cost is dramatically reduced. Moreover, the device and various test equipment are registered and synchronized by various ways so that the testing and analysis process is more convenient. The security of firmware installed is ensured. Firmware debugging and confirmation time after debugging are reduced.

### BACKGROUND OF THE INVENTION

1. Field of the Invention

The present invention relates to a data collection and analysis device that downloads and updates firmware from operation platforms and an operating method of the same, especially to a data collection and analysis device that is used together with different test equipment so that users don't need to buy a plurality of data collection and analysis devices according to requirements of different tests. The equipment cost is dramatically reduced and the testing and analysis process is more easy and convenient. Moreover, the security of the firmware installed in the core unit is ensured. The firmware debugging time and confirmation time after debugging are both reduced

2. Description of Related Art

Generally, different items such as temperature, weight, wind speed, etc. are run by various types of test equipment. For various types of analysis, data measured and collected by the test equipment is sent to a corresponding data collection and analysis device connected to the test equipment.

However, while in use, each of various types of test equipment has its corresponding data collection and analysis device. Thus the cost spent on data collection and analysis devices corresponding to various types of test equipment is a heavy burden for users. Moreover, users need to learn operations of each kind of data collection and analysis device and this is inconvenient.

Thus there is room for improvement and a need to provide a novel data collection and analysis device and an operating method of the same that overcome the above shortcomings and having a higher practical value.

### SUMMARY OF THE INVENTION

Therefore it is a primary object of the present invention to provide a data collection and analysis device and an operating method of the same that make testing and analysis process more simple and convenient. Moreover, the firmware debugging time and confirmation time after debugging are both reduced. The device is of higher practical value while in use.

In order to achieve the above object, a data collection and analysis device of the present invention includes a core unit that works online or off-line, a program conducting and loading unit that is connected to the core unit and is used to download MCU (microcontroller) firmware, a translation unit that is connected to the core unit and the program conducting and loading unit and used for simulation of bidirectional user interface translation on different platforms, a communication interface that is connected to the program conducting and loading unit and the translation unit and is used for connection to different platforms, a transmission unit that is connected to the core unit and is used for automatic registration and synchronization of various test equipment, a memory unit that is connected to the core unit and is used for storage data transmitted from the core unit, an indicator light unit connected to the core unit and used for showing various operation states of the data collection and analysis device, and an input unit connected to the core unit and used for various inputs. Thereby users don't need to buy a plurality of data collection and analysis devices according to requirements of different tests. The cost spent on equipment is significantly reduced. Moreover, the data collection and analysis device and the test equipment are registered and synchronized by magnetic force, electric field, light, wireless way, radio frequency module, etc.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of an embodiment according to the present invention;

FIG. 2 is a flow chart showing an embodiment of the present invention in operation.

### DETAILED DESCRIPTION OF THE PREFERRED EMBODIMENT

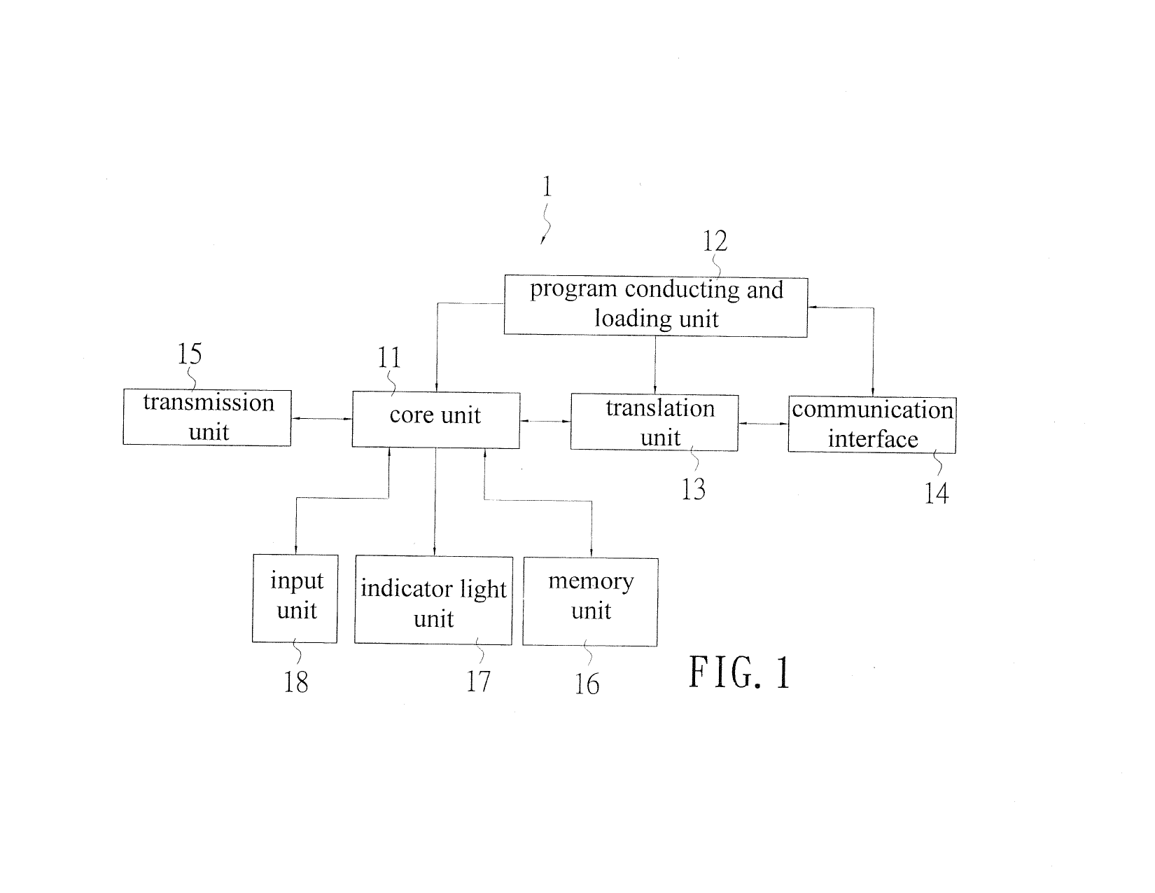

Refer to FIG. 1, a data collection and analysis device 1 of the present invention includes a core unit 11, a program conducting and loading unit 12, a translation unit 13, a communication interface 14, a transmission unit 15, a memory unit 16, an indicator light unit 17, and an input unit 18.

The core unit 11 works online or off-line.

The program conducting and loading unit 12 is connected to the core unit 11 and is used to download MCU (microcontroller) firmware, allowing the data collection and analysis device 1 executes multiple functions on different platforms such as an operating system (O.S) or a wireless host.

The operating system can be one of the followings:
1. i-OS: IPADx, IPHONEx, IPOD-touchx;
2. Android: 2 . 3 . X, 3 . X, 4 . X;
3. Symbian;
4. Windows: PC, tablet, Mobile;
5. Apple: MAC;

The wireless host can be:
1. PC dongle;
2. ODM wireless Host.

The translation unit 13 is connected to the core unit 11 and the program conducting and loading unit 12, used for simulation of bidirectional user interface translation on different platforms such as an operating system or a wireless host.

The communication interface 14 is connected to the program conducting and loading unit 12 and the translation unit 13. It can be a wired communication interface such as UART (universal asynchronous receiver/transmitter), USB (Universal Serial Bus)/UST(Universal Serial transmitter) OTG (On The Go), Ethernet, LAN (local area network) or a wireless communication interface such as Wi-Fi, Bluetooth used for connection to different platforms such as an operating system or a wireless host.

The transmission unit 15 is connected to the core unit 11 for performing automatic registration and synchronization by magnetic force (such as hall sensor), electric field (such as Coil inductor), light (such as Infrared IrDA), wireless way (such as low energy wireless), or radio frequency module such as sub-GHz, 2.4 GHz, ZigBee, Bluetooth, Wi-Fi a/b/g/n) while getting close to various test equipment.

The memory unit 16 is connected to the core unit 11. It can be internal memory such as Nand flash, EEPROM (electrically erasable programmable read-only memory), or external memory such as SD card, used for storage data transmitted from the core unit 11.

The indicator light unit 17 is connected to the core unit 11 and is used for showing various operation states of the data collection and analysis device 1 such as power state, link state, abnormal state, etc.

The input unit 18 is connected to the core unit 11 and is used for various inputs such as turning on, turning off, etc.

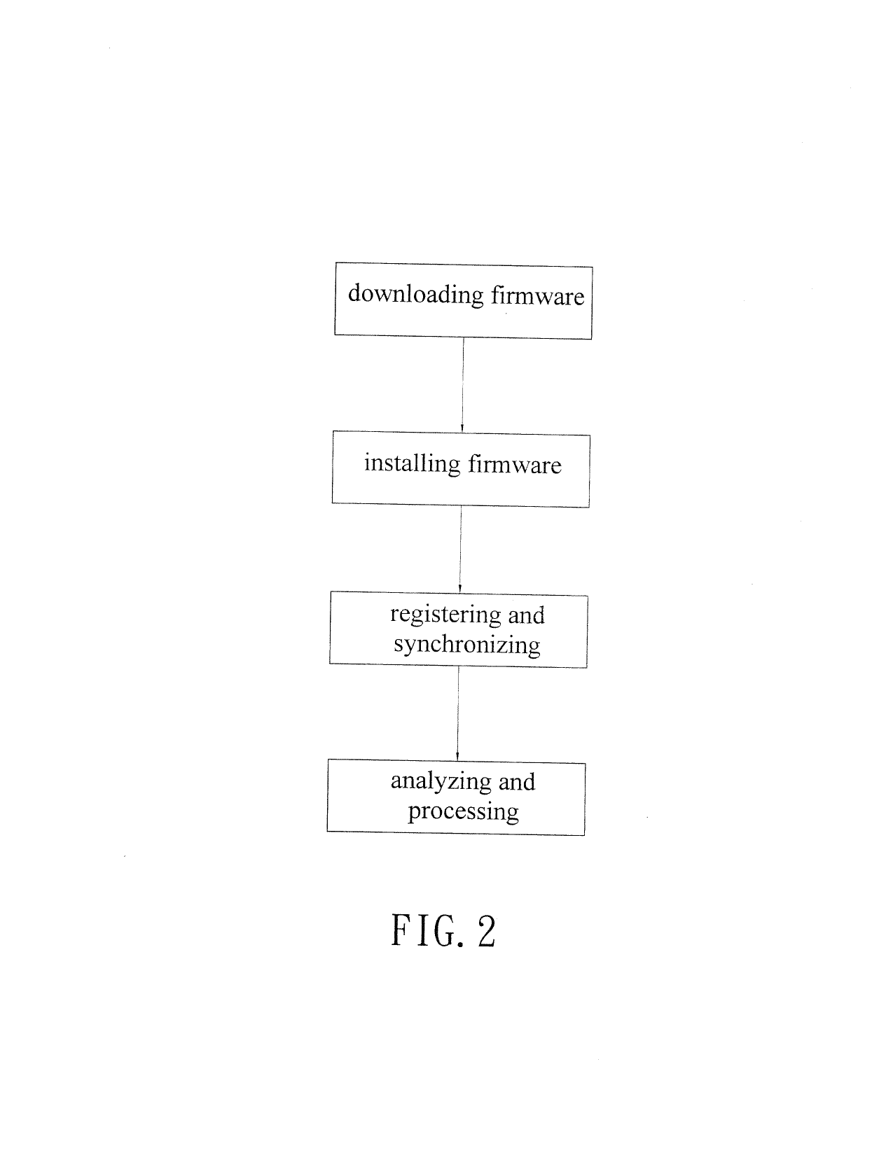

Refer to FIG. 2, a flow chart showing an operating method of a data collection and analysis device 1 is revealed. The operating method includes following steps:

downloading firmware: the communication interface 14 is connected to an operation platform to download firmware required for different tests;

installing firmware: the downloaded firmware is communicated by the program conducting and loading unit 12, translated by the translation unit 13, and then is installed into the core unit 11;

registering and synchronizing: launch the firmware installed in the core unit 11. After a piece of test equipment corresponding to the downloaded firmware and the transmission unit 15 being registered and synchronized, data signals obtained by the test equipment is transmitted to the core unit 11 through the transmission unit 15; and

analyzing and processing: the core unit 11 analyzes and processes the data signals obtained by the test equipment independently after the data signals being transmitted to the core unit 11 if the communication interface 14 is not connected to the operation platform. Once the communication interface 14 is connected to the operation platform, the core unit 11 sends the received data signals to the operation platform connected thereof through the communication interface 14. The operation platform performs analysis and processing and then displays results of analysis and processing on a screen thereof.

Moreover, when users intend to perform different test items, the related firmware required is downloaded into the core unit 11 again. Thus different kinds of data is collected and analyzed by the data collection and analysis device 1 of the present invention.

In summary, the present invention has following advantages compared with the device available now:

1. The data collection and analysis device of the present invention downloads, updates and installs different firmware according to the type of the test. Thus users don't need to buy a plurality of different data collection and analysis devices according to various requirements of different tests. Therefore the equipment cost is dramatically reduced.

2. The data collection and analysis device of the present invention is connected to various platforms by wire communication or wireless communication. And the data collection and analysis device and the test equipment are registered and synchronized by magnetic force, electric field, light, wireless way, radio frequency module, etc. Thus the testing and analysis process is more simple and convenient.

3. In the data collection and analysis device of the present invention, the downloaded updated firmware is communicated by the program conducting and loading unit and then is installed in the core unit. By the data collection and analysis device, the security of the firmware installed in the core unit is ensured. Moreover, installation in the core unit can reduce time spent on firmware debugging and confirmation after debugging.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A data collection and analysis device that downloads and updates firmware from operation platforms comprising:
a core unit that works online or off-line;
a program conducting and loading unit that is connected to the core unit and is used to download MCU (microcontroller) firmware, allowing the data collection and analysis device working on different platforms;
a translation unit that is connected to the core unit and the program conducting and loading unit, used for simulation of bidirectional user interface translation on different platforms;
a communication interface that is connected to the program conducting and loading unit and the translation unit and is used for connection to different platforms;
a transmission unit that is connected to the core unit and is used for registration and synchronization of various test equipment;
a memory unit that is connected to the core unit and is used for storage data transmitted from the core unit;
an indicator light unit that is connected to the core unit and is used for showing various states of the data collection and analysis device; and
an input unit that is connected to the core unit and is used for various inputs.

2. The device as claimed in claim 1, wherein the data collection and analysis device works on different operating systems.

3. The device as claimed in claim 1, wherein the data collection and analysis device works on a wireless host.

4. The device as claimed in claim 1, wherein the communication interface is a wired communication interface.

5. The device as claimed in claim 1, wherein the communication interface is a wireless communication interface.

6. The device as claimed in claim 1, wherein the transmission unit and the test equipment are registered and synchronized by using at least one way selected from magnetic force, electric field, light, wireless way, and radio frequency module.

7. The device as claimed in claim 1, wherein the memory unit is internal memory.

8. The device as claimed in claim 1, wherein the memory unit is external memory.

9. An operating method of a data collection and analysis device that downloads and updates firmware from operation platforms comprising the steps of:
downloading firmware: downloading firmware required for different tests after a communication interface of the data collection and analysis device being connected to an operation platform;
installing firmware: communicating the firmware downloaded by a program conducting and loading unit of the data collection and analysis device, translating the firmware by a translation unit of the data collection and analysis device, and then installing the firmware into a core unit of the data collection and analysis device;
registering and synchronizing: launching the firmware installed in the core unit and sending data signals obtained by test equipment to the core unit through a transmission unit of the data collection and analysis device after the test equipment corresponding to the downloaded firmware and the transmission unit being registered and synchronized; and
analyzing and processing: analyzing and processing the data signals independently by the core unit after the data signals obtained by the test equipment being sent to the core unit.

10. An operating method of a data collection and analysis device that downloads and updates firmware from operation platforms comprising the steps of:
downloading firmware: downloading firmware required for different tests after a communication interface of the data collection and analysis device being connected to an operation platform;
installing firmware: communicating the firmware downloaded by a program conducting and loading unit of the data collection and analysis device, translating the firmware by a translation unit of the data collection and analysis device, and then installing the firmware into a core unit of the data collection and analysis device;
registering and synchronizing: launching the firmware installed in the core unit and sending data signals obtained by test equipment to the core unit through a transmission unit of the data collection and analysis device after the test equipment corresponding to the downloaded firmware and the transmission unit being registered and synchronized; and
analyzing and processing: the core unit sending the data signals to the operation platform through the communication interface after the data signals obtained by the test equipment being sent to the core unit and the communication interface being connected to the operation platform, then analyzing and processing the data signals by the operation platform and displaying analyzing and processing results on a screen of the operation platform.
